(19) United States
(12) Patent Application Publication
(10) Pub. No.: US 2012/0184706 A1
(43) Pub. Date: Jul. 19, 2012

(54) METHOD FOR SYNTHESIZING POLYESTERS IN AN ACIDIC IONIC LIQUID MEDIUM

(76) Inventors: Alain Fradet, Issy les Moulineaux (FR); Hervé Lefebvre, Viroflay (FR); Jean-Pierre Bazureau, La Chapelle des Fougeretz (FR); Ludovic Paquin, Guipel (FR); Daniel Carrie, Vezin Le Coquet (FR)

(21) Appl. No.: 13/386,448

(22) PCT Filed: Jul. 28, 2010
(86) PCT No.: PCT/FR2010/051605

§ 371 Date: Mar. 30, 2012

(30) Foreign Application Priority Data
Jul. 31, 2009 (FR) 0955403

(51) Int. Cl. C08G 63/16; C08G 63/78; C08G 63/06

(52) U.S. Cl. 528/274; 528/272; 528/361

(57) ABSTRACT

The present invention relates to a method for synthesizing polyesters or copolyesters having a mean molar mass in mass M_{W}, greater than 10000, by means of a direct polyesterification reaction between a diacid, diester, hydroxyacid, or hydroxyester and a diol, or between hydroxyacids or hydroxyesters, said method being characterized in that said polyesterification reaction is carried out at a temperature of 60 to 150° C. at atmospheric pressure in a reaction medium including at least one acidic ionic liquid consisting of an anion and a cation, the electrical charges of which balance each other out, and wherein at least the cation is a strong acid according to the Bronsted definition, or comprises a grouping that is a strong acid according to the Bronsted definition.

The present invention relates to a process for synthesizing polyesters under mild conditions using ionic liquids or mixtures of ionic liquids that act both as solvents and as catalysts.

Polyesters are polyvalent biodegradables and/or recyclable thermoplastics that are undergoing rapid development for environmental applications, such as compostable aliphatic or aliphatic-aromatic polyesters, or for biomedical applications, such as lactide, glycolide, p-dioxanone or caprolactone copolymers.

Polyesters may be obtained via three major synthetic routes [(Fradet, A.; Tessier, M. Polyesters.,

in Synthetic methods in step-growth polymers. M. E. Rogers and T. E. Long, Eds. New York, J. Wiley & Sons: 17-132 (2003)]:

(i) polymerization via the opening of lactone rings, which addresses a few specific monomers;

(ii) solution polymerization at low temperature (0-120° C.) using highly reactive monomers such as acid dichlorides, or using dicarboxylic acids in the presence of activating agents, and

(iii) bulk polyesterification at high temperature (170-300° C.) between dicks and diacids or diesters, generally under vacuum, for several hours and in the presence of organometallic catalysts.

Ionic liquids (IL) are generally defined as being organic salts with a melting point below the boiling point of water [Wasserscheid, P.; Welton, T., Ionic Liquids in Synthesis, 2nd edition, Wiley-VCH, Weinheim: 2007]. They are formed from the combination of an anion and a cation in stoichiometric proportions ensuring the electrical neutrality of the salt.

The cations are generally bulky and of low symmetry. The ones most commonly used are of ammonium, imidazolium, pyridinium, pyrrolidinium or phosphonium type structure. Imidazolium is the cation most frequently represented in publications, especially N,N′-dialkylimidazolium cations which have advantageous physicochemical properties, in particular a relatively low melting point.

The anions are simple anions, for example halides, or polynuclear anions. The polynuclear anions of “Lewis acid” nature of first-generation ILs (Al₂Cl₇⁻, Al₃Cl₁₀⁻, Au₂Cl₇⁻, Fe₂Cl₇⁻, . . . ), which are very water-sensitive and sparingly stable in ambient air, have been replaced in 2nd-generation ILs by much more stable anions, for instance bis((trifluoromethyl)sulfonyl)imidate [Tf₂N⁻], bis(methylsulfonyl)imidate [(MeS)₂N⁻], dicyanamide [N(CN)₂⁻] and hexafluorophosphate (PF₆⁻) anions [MacFarlane, D. R. et al., Chem. Commun., 2001, 1430].

The novel physicochemical properties of ILs make them media of choice for organic synthesis, and their use as solvents for synthetic chemistry has undergone a boom in the last decade. The reason for this is that they have a negligible vapor pressure and very good chemical and thermal stability, and are non-flammable and readily recyclable. They also enable transformations that are often more selective and faster than in standard solvents. Many' reactions of organic chemistry have been stated in these novel media: electrochemical reactions, nucleophilic or electrophilic substitution or addition reactions, ene-synthesis reactions and oxidation reactions [Wasserscheid, P.; Welton, T., 2007, ibid].

Ionic liquids have proven to be particularly advantageous for four types of reaction: i) nucleophilic substitutions, ii) reactions under acidic catalysis or Friedel-Crafts reactions, iii) reactions conducted at high temperature (rearrangements, Diels-Alder and Heck reactions) and iv) oxidations and epoxidations.

Large-scale industrial applications of ILs have been developed, such as the Dimersol process of the Institut Francais du Pétrole for the dimerization of alkenes [Chauvin, Y., Angew. Chem. Int. Ed, 2006, 45, 3740], the Eastman process for the isomerization of an epoxybutene [Holbrey, J. D.; Plechkova, N. Y.; Seddon, K. R. Green Chemistry 2006, 8, 411] and the Basil phosphorylation process from BASF as described in international patent application WO 2003/062 171.

It rapidly appeared advantageous to introduce strong acid groups (Bronsted acids) into the anions or cations of ionic liquids in order to give them catalytic properties. The first Bronsted-acid ionic liquids described in the literature comprise an alkyl chain with a sulfonic acid function on a cation of imidazolium or phosphonium type [Cole, A. C. et al., J. Am. Chem. Soc. 2002, 124, 5962]. These ILs were used as solvents and catalysts in Fisher esterification reactions and then in dimerization reactions of primary alcohols for the preparation of ethers. Thereafter, analogs containing a pyridinium cation were synthesized and also used for esterification reactions [Xing, H. et al, Ind. Eng. Chem. Res. 2005, 44, 4147]. It is also possible to introduce the acidic nature into an IL by using an anion of the type HSO₄⁻ or H₂PO₄⁻. [International patent application WO 2000/016 902; Fraga-Dubreuil, J. et al., Cat. Commun. 2002, 3, 185]. Arfan et al, showed that N-alkylpyridinium hydrogen sulfates ([Me(CH₂)ₙPy][HSO₄]) are excellent catalysts for esterification reactions of various acids with neopentanol [Arfan, A. et al., Org. Process Res. Dev. 2005, 9, 743]. The esterification reactions are performed in very good yields and recycling of the solvent-catalysts is possible by simple decantation.

Although an increasing number of studies is published on the subject, polymerization reactions in these media are much less documented. Besides electrochemical polymerizations leading to conductive polymer films (poly(p-phenylene), polythiophenes or polypyrroles) and which constitute a very particular category of reactions, the majority of the articles are concerned with radical polymerizations [Kubisa, P., Prog. Polym. Sci., 2004, 29, 3; Kubisa, P., J. Polym. Sci. Part A: Polym. Chem., 2005, 43, 4675; Strehmel, V. et al., Macromolecules, 2006, 39, 923; Carmichael, A. C. et al., Chem. Commun., 2000, 22, 1237]. A few cationic, anionic or coordination polymerization reactions have also been described [Mastrorilli, P. et al., J. Mol. Cata. A: Chem., 2002, 184, 73]. In all these polymerizations, the advantage afforded by using IL is that it allows easier separation and recycling of the catalyst, removal from the polymer of potentially toxic metallic catalysts, and, in certain cases, access to higher polymerization rates and molar masses.

Few studies describe polycondensation and polyaddition reactions in ILs, these studies for the most part concerning the synthesis of high-performance polymers in very dilute medium, such as aromatic polyoxathiazoies, polyimides and polyamides [Vygodskii, Y. S. et al, Macromol. Rapid Comm. 2002, 23, 676; Mallakpour, S. et al., High Perform. Polym., 2007, 19, 427]. Certain polyesterification reactions in ILs have recently been studied (synthesis of glycolic acid copolymers) [Dali, S. et al., J. Polym. Sci. Part A: Polym. Chem., 2006, 44, 3025; Dali, S. et al., e-Polymers, 2007, No. 065] and two types of difficulty have been revealed: (i) solubility problems when the molar mass of the polymer increases, and (ii) relatively poor efficacy of standard bulk polyesterification catalysts, generally Lewis acids, solvents or metal alkoxides. Attention should also be drawn to the article by Chengjie F. et al., Polymer, 2008, 49, 461-466, which describes the synthesis of aliphatic polyesters in non--acidic ionic liquid medium by polycondensation of oligomers at high temperature (100-220° C.) and international patent application WO 2008/043 837, which describes ionic liquids as polymer solvents, but without catalytic properties.

The main methods for synthesizing polyesters have the drawback either of using volatile organic solvents and reagents that give rise to a harmful evolution of hydrochloric acid (in the case of acid chlorides), or of requiring the use of high temperatures that are not always compatible with the nature of the polyesters to be synthesized.

The inventors thus set themselves the aim of providing a process for the synthesis of polyesters that is quick and simple to perform, under mild conditions that do not give rise to any harmful evolution of hydrochloric acid, while at the same time taking place at lower temperatures than those usually used in the prior art, and without using a metallic catalyst.

This aim is achieved by the synthetic process that is the subject of the present invention, and which will be described below. The inventors have in fact discovered that the synthesis of polyesters with a mass-average molar mass Mw>10 000 can be performed by direct polyesterification in ionic liquids in which the anion, the cation or both have Bronsted acid nature, at a much lower temperature and for much shorter reaction times than those required for the preparation of polyesters via standard bulk or solution methods.

One subject of the present invention is thus a process for synthesizing polyesters or copolyesters with a mass--average molar mass Mw of greater than 10 000, said mass-average molar mass being measured by steric exclusion chromatography:

i) via a polyesterification reaction between at least a first monomer or oligomer chosen from compounds bearing at least two carboxylic acid functions, compounds bearing at least two carboxylic acid ester functions, compounds bearing at least one carboxylic acid function and at least one hydroxyl function, compounds bearing at least one carboxylic acid ester function and at least one hydroxyl function, and at least a second monomer or oligomer chosen from compounds bearing at least two hydroxyl functions, or

ii) via a polyesterification reaction of a single monomer or oligomer chosen from compounds bearing at least one carboxylic acid function and at least one hydroxyl function and compounds bearing at least one carboxylic acid ester function and at least one hydroxyl function;

said process being characterized in that said polyesterification reaction is performed at a temperature from 60 to 150° C., at atmospheric pressure or under vacuum, in a reaction medium free of metallic catalyst and comprising at least one acidic ionic liquid formed from an anion and the cation whose electrical charges are equilibrated and in which at least the cation is a strong acid in the Bronsted sense or comprises a group that is a strong acid in the Bronsted sense.

According to the invention, the term “strong acid in the Bronsted sense” means any chemical species that is capable of yielding one or more protons of H⁺.

By using such acidic ionic liquids, which have catalytic properties, as reaction medium, the present invention allows the synthesis of polyesters under mild conditions and at moderate temperature. The synthetic process in accordance with the present invention makes it possible to reduce considerably the reaction temperature and time and to recycle easily the solvent-catalyst. Reducing the reaction temperatures also allows the direct synthesis of functional polyesters bearing thermally fragile units having, for example, biological activity.

More specifically, the polyesterification reactions used in the present invention are condensation reactions (1) between groups of carboxylic acid type and groups of alcohol type, and/or (2) between groups of carboxylic acid ester type and groups of alcohol type and/or (3) between groups of carboxylic acid type and groups of carboxylic acid ester type. These reactions are well known to those skilled in the art for leading to polyesters, and are respectively written:

R—COOH (group A)+HO—R′ (group B)→R—COO—R′+H₂O (1)

R—COOR¹(group A)+HO—R′ (group B)→R—COO—R¹+R¹OH (2)

R—COOH (group A)+R²COO—R′ (group B)→R—COO—R′+R²COOH (3)

in which:

R and R′, independently of each other, represent any type of monomer, oligomer or polymer molecule that can lead to a polymer molecule of high molar mass,

R¹ is an alkyl group, preferably a methyl, ethyl, propyl, isopropyl, butyl or isobutyl group, and

R² is an alkyl group, preferably a methyl or ethyl group.

In the text hereinbelow, these polymerization reactions are referred to as “polyesterifications”, the groups of carboxylic acid type —COOH and ester derivatives —COOR¹ are referred to as “groups of type A” and the groups of alcohol type —OH and ester derivatives —OOCR² are referred to as “groups of type B”.

According to the synthetic process in accordance with the present invention, the compounds reacted together to perform the polyesterification reaction bear either one or more groups of type A and are chosen from compounds of the type A, corresponding to formula I below (A)ₓR³, or one or more groups of the type B and are chosen from compounds of the type Bₓ corresponding to formula II below (B)_{y}R⁴, or one or more groups of the type A and one or more groups of the type B and are chosen from compounds of the type AₓB_{y} corresponding to formula III below (A)ₓR⁵(B)₃, in which formulae I, II and III:

x and y are integers greater than or equal to 1, and

the groups R³, R⁴ and R⁵, independently of each other, are aliphatic, cycloaliphatic, aromatic or mixed groups, optionally containing heteroatoms or groups that are not reactive under the synthetic conditions used, for example ketone, sulfone, amide or imine groups.

The polyesters obtained in accordance with the process of the invention are of linear or branched, optionally crosslinked architecture.

As is well known to those skilled in the art, the stoichiometric ratio between mutually reactive groups (groups of type A, on the one hand, and groups of type B, on the other hand) may be adjusted to obtain either a polymer of high molar mass, or an oligomer bearing reactive end groups, or unbranched polymer, or a crosslinked polymer.

According to a first embodiment of the process in accordance with the present invention, the compounds reacted together to perform the polyesterification reaction contain either two groups of the type A (compounds of type A₂), or two groups of the type B (compounds of type B₂), or a group of the type A and a group of the type B (compounds of type AB) and the polyester or copolyester obtained is of linear architecture. Thus, the reaction:

(i) of one or more compounds of the type A₂ with one or more compounds of the type B₂, or

(ii) the reaction of one or more compounds of the type AB, or

(iii) the reaction of one or more compounds of the type A₂ with one or more compounds of the type B₂ and one or more compounds of the type AB

under the conditions of the present invention leads to a polymer of linear architecture, optionally of alternating nature, i.e. in which the monomer units of the same type follow each other in a regular and repeated sequence along the chain (for example type-1-type-2-type-3-type-1-type-2-type-3-etc. . . . ).

According to one particular embodiment of the invention, the esterification reaction is performed by reacting either one or more compounds containing only one group of type A and several groups of type B (compounds of the type ABₓ) optionally with a compound containing several groups of type B, or one or more compounds containing several groups of type A and only one group of type B (compounds of the type AₓB) optionally with a compound containing several groups of type A, which leads to polymers (polyesters or copolyesters) of highly branched architecture, which are referred to as being hyperbranched.

According to another embodiment of the process in accordance with the present invention, the composition of the medium is adjusted between compounds containing several groups of type A and/or several groups of type B according to calculations known to those skilled in the art in order to obtain an insoluble or unmeltable crosslinked polymer.

According to yet another embodiment of the process in accordance with the present invention, one or more of the reacted compounds are oligomers, for example polyesters, polyethers, polyamides or polyimines, bearing reactive groups of the type A and/or B. The polyesters obtained then contain polymer blocks of different types and are generally referred to as block copolymers.

The acidic-cation ionic liquids that may be used according to the process of the present invention are preferably chosen from ionic liquids of formula qXⁿ⁺nY^{q-} in which Xⁿ⁺ denotes an acidic cation bearing a positive charge (n=1) or several positive charges (n>1) and Y^{q-} denotes an anion bearing a negative charge (q=1) or several negative charges (q>1).

Among such cations Xⁿ⁻, mention may be made especially of the ammoniums, imidazoiums, pyridiniums, pyrrolidiniums, piperidiniums, triazoliums, morpholiniums and phosphoniums of general formulae X1 to X8 below:

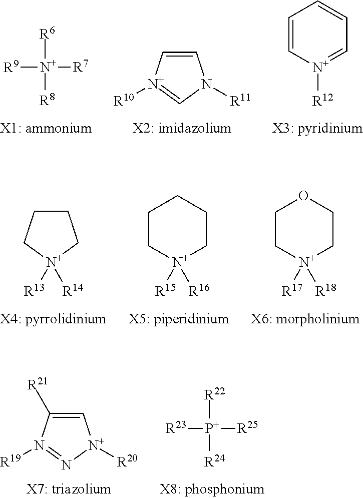

in which:

the radicals R⁶ to R¹¹ and R¹³ to R²⁵, independently of each other, represent a hydrogen atom, an arylsulfonic acid group of formula —(CH₂)ₘ—SO₃H, in which m is an integer ranging from 1 to 6 and preferentially m=3 or 4, an aliphatic group, a cycloaliphatic group, an aromatic group or a mixed group, said groups optionally containing one or more heteroatoms; it being understood that in each of the cations of formulae X1 to X8 above, at least one of the radicals Rⁿ represents a hydrogen atom or an alkylsulfonic acid group of formula —(CH₂)ₘ—SO₃H;

R¹² represents a hydrogen atom or an alkylsulfonic acid group of formula —(CH₂)ₚ—SO₃H, in which p is an integer ranging from 1 to 6, and preferentially p=3 or 4.

For the purposes of the present invention, the term “mixed group” means a group formed from parts of different types, namely aliphatic and/or cycloaliphatic and/or aromatic.

The anion Y^{q-} of the ionic liquid, bearing one (q=1) or more negative charges (q>1), is preferably chosen from mononuclear anions, such as halides (Y═F, Cl, Br, I); polynuclear anions, such as tetrafluoroborate (Y═BF₄), hexafluorophosphate (Y═PF₆), sulfate (Y═SO₄), hydrogen sulfate (Y═HSO₄), dihydrogen phosphate (Y═H₂PO₄), hydrogen phosphate (Y═HPO₄) and phosphate (Y═PO₄) anions; carboxylase anions, for instance formates (Y═HCOO); acetate anions (Y═CH₃COO); trifluoroacetate anions (Y═CF₃COO); propanoate anions (Y═CH₃—CH₂—COO); bis((trifluoromethyl)sulfonyl)imidate anions (Y═(CF₃—SO₂)₂N); bis(methylsulfonyl)imidate anions (Y═(CH₃—SO₂)₂ N); dicyanamidate anions (Y═N(CN)₂); sulfonate anions, for instance methylsulfonate (Y═CH₃—SO₃), trifluoromethylsulfonate (Y═CF₃SO₃), benzenesulfonate (Y═C₆H₅—SO₃) and p-toluenesulfonate (Y═CH₃—C₆H₄—SO₃).

The ionic liquid that may be used in accordance with the invention may also be chosen from ionic liquids in which the cation is chosen from one of the cations of formulae X1 to X8 above and in which the anion Y^{q-} comprises at least one Bronsted acid group chosen from the acidic anions of protic polyacids, for instance the hydrogen sulfate anion (Y═HSO₄) or the dihydrogen phosphate anion (Y═H₂PO₄).

According to one particularly preferred embodiment of the invention, the ionic liquid is chosen from the 3-(3-alkyl-1-imidazolio)-1-propanesulfonic acids and 4-(3-alkyl-1-imidazolio)-1-butanesulfonic acids of formula (IV) below:

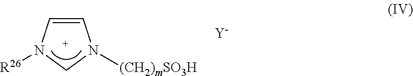

in which m=3 or 4, Y is chosen from the anions Y^{q-} as defined above and R²⁶ is an aliphatic group, a cycloaliphatic group, an aromatic group or a mixed group, said groups optionally containing one or more heteroatoms.

The ionic liquids of formula (IV) above are preferably chosen from the hydrogen sulfates, trifluoromethanesulfonates, tosylates, dihydrogen phosphates and bis(trifluoromethylsulfonyl)imidates of the following acids:

4-(3-methyl-1-imidazolio)-1-butanesulfonic, 3-(3-triethyl-1-imidazolio)-1-propanesulfonic, 4-(3-ethyl-1-imidazolio)-1-butanesulfonic, 3-(3-ethyl-1-imidazolio)-1-propanesulfonic, 4-(3-propyl-1-imidazolio)-1-butanesulfonic, 3-(3-propyl-1-imidazolio)-1-propanesulfonic, 4-(3-butyl-1-imidazolio)-1-butanesulfonic, 3-(3-butyl-1-imidazolio)-1-propanesulfonic, 4-(3-isobutyl-1-imidazolio)-1-butanesulfonic, 3-(3-isobutyl-1-imidazolio)-1-propanesulfonic, 4-(3-pentyl-1-imidazolio)-1-butanesulfonic, 3-(3-pentyl-1-imidazolio)-1-propanesulfonic, 4-(3-hexyl-1-imidazolio)-1-butanesulfonic, 3-(3-hexyl-1-imidazolio)-1-propanesulfonic, 4-(3-octyl-1-imidazolio)-1-butanesulfonic, 3-(3-octyl-1-imidazolio)-1-propanesulfonic, 4-(3-dodecyl-1-imidazolio)-1-butanesulfonic, 3-(3-dodecyl-1-imidazolio)-1-propanesulfonic, 4-(3-octadecyl-1-imidazolio)-1-butanesulfonic, 3-(3-octadecyl-1-imidazolio)-1-propanesulfonic, 4-(3-(2-ethoxyethyl)-1-imidazolio)-1-butanesulfonic, 3-(3-(2-ethoxyethyl)-1-imidazolio)-1-propanesulfonic, 4-(3-(2-methoxyethyl)-1-imidazolio)-1-butanesulfonic, 3-(3-(2-methoxyethyl)-1-imidazolio)-1-propanesulfonic, 4-(3-(2(2-methoxyethoxy)ethyl)-1-imidazolio)-1-butanesulfonic and 3-(3-(2(2-triethoxyethoxy)ethyl)-1-imidazolio)-1-propanesulfonic.

According to the present invention, the acidic ionic liquid may by itself constitute the reaction medium. In this case, the reaction medium may be formed from a single acidic ionic liquid or from a mixture of two or more of the acidic ionic liquids as defined according to the invention.

In addition to the acidic ionic liquid(s) that may be used according to the invention, the reaction medium may also comprise at least one nonacidic ionic liquid. Among such nonacidic ionic liquids, mention may be made especially, as nonlimiting examples, of 1-butyl-3-methylimidazolium chloride, 1-butyl-3-methylimidazolium tetrafluoroborate and butyl-3-methylimidazolium bis(trifluoromethylsulfonyl)imidate.

According to the present invention, the compounds reacted together to perform the polyesterification reaction are present in the reaction medium in an amount such that the mass proportion of the final polymer is between 1% and 99% and preferentially between 10% and 70% relative to the total mass of the reaction medium.

The temperature of the reaction medium is preferably from 80 to 120° C. approximately at atmospheric pressure.

According to one variant of the present invention, a stream of inert gas (for example nitrogen or argon) is introduced over or into the reaction medium during the polyesterification reaction. This makes it possible to facilitate the removal of the reaction byproduct (water, alcohol, acid) and thus promotes the production of a polyester of high molar mass.

According to another variant of the present invention, a vacuum of from 0.1 to 100 mbar is applied over the reaction medium during the polyesterification reaction. This makes it possible to facilitate the removal of the reaction byproduct (water, alcohol, acid) and thus promotes the production of a polyester of high molar mass.

The duration of the polyesterification reaction may range from 1 minute to 48 hours and depends on the temperature used, an increase in temperature resulting in a reduction of the time necessary to obtain a polymer having the desired molar mass.

According to a preferred embodiment of the process in accordance with the invention, the polyesterification reaction is performed for 30 minutes at about 110° C.

At the end of the polyesterification reaction, the reaction medium is allowed to return to room temperature and the polymer may be recovered via separation techniques that are well known to those skilled in the art, for instance by filtration if the polymer precipitates at room temperature.

If the polymer is soluble in the reaction medium at room temperature, it may be recovered by precipitation from a nonsolvent for the polymer, for example water, methanol, ethanol or isopropanol or by extraction with a solvent for the polymer, for example chloroform or toluene. The acidic ionic liquid may then be used for a new reaction, after evaporation of the nonsolvent or of the solvent, if one has been added.

The present invention is illustrated by the following preparation examples, to which it is not, however, limited.

### EXAMPLES

In the following examples, Mw means the mass-average molar mass and was measured by steric exclusion chromatography (CH₂Cl₂, 1 mL/min, Phenomenex® columns (Phenogel 10⁵, 10⁴, 10³, 500, 100A), refractometric detection, polystyrene calibration).

### Example 1

### Preparation of a polyester of 12-hydroxydodecanoic acid (12-HDA)

216 mg of 12-HDA (1 mmol) and 358 mg (1 mmol) of ionic liquid (4-(3-butyl-1-imidazolio)-1-butanesulfonic acid: [BIm4S], HSO₄) were placed in a 15 mL ground-necked tube equipped with a nitrogen inlet and outlet and magnetic-flea stirring. The mixture was stirred for 30 minutes at 110° C. under a nitrogen flow rate of 500 mL/minute. 10 ml of 2-propanol were then added, and the reaction medium was refluxed for 5 minutes. After cooling with stirring, a white solid was obtained. After filtering off and drying under vacuum, 180 mg of white solid were recovered. Mw=35800; ¹H NMR (CDCl₃, 300 MHz, ref. δ (CHCl₃)=7.26 ppm): δ=4.05 (2H, t); 2.34 (2H, t); 2.28 (2H, t); 1.60 (4H, m); 1.27 ppm (14H, m),

### Example 2

### Preparation of a polyester of 12-hydroxydodecanoic acid (12-HDA) in [BIm4S].Tf₂N

216 mg of 12-HDA (1 mmol) and 541 mg (1 mmol) of 4-(3-butyl-1-imidazolio)-1-butanesulfonic acid bis((trifluoromethyl)sulfonyl)imidate, [BIm4S].Tf₂N) were placed in a 15 mL ground-necked tube equipped with a nitrogen inlet and outlet and magnetic-flea stirring. The mixture was stirred for 10 minutes at 110° C. under a vacuum of 10 mbar, 10 ml of 2-propanol were then added, and the reaction medium was refluxed for 5 minutes. After cooling with stiffing, a white solid was obtained. After filtering off and drying under vacuum, 185 mg of white solid were recovered. Mw=31200; ¹H NMR (CDCl₃, 300 MHz, ref. δ (CHCl₃)=7.26 ppm): δ=4.05 (2H, t); 2.34 (2H, t); 2.28 (2H, t); 1.60 (4H, m); 1.27 ppm (14H, m).

### Example 3

### Preparation of a polyester of 12-hydroxydodecanoic acid (12-HDA) in a mixture of [BIm4S].HSO₄—[BMIm].Tf₂N

216 mg of 12-HDA (1 mmol), 398 mg of [BMIm].Tf₂N (0.95 mmol) and 18 mg of [BIm4S].HSO₄ (0.05 mmol) were placed in a 15 mL ground-necked tube equipped with a nitrogen inlet and outlet and magnetic-flea stirring. The mixture was stirred for 2 hours at 110° C. under a vacuum of 10 mbar. 10 ml of 2-propanol were then added, and the reaction medium was refluxed for 5 minutes. After cooling with stirring, a white solid was obtained. After filtering off and drying under vacuum, 164 mg of white solid were recovered. Mw=53300; ¹H NMR (CDCl₃, 300 MHz, ref. δ (CHCl₃)=7.26 ppm): δ=4.05 (2H, t); 2.34 (2H, t); 2.28 (2H, t); 1.60 (4H, m); 1.27 ppm (14H, m).

### Example 4

### Preparation of an L-lactic acid polyester

300 mg of L-lactic acid as a 90% solution in water (dehydrated and oligomerized beforehand under vacuum for 4 hours at 100° C.) and 300 mg of BIm4S.HSO₄ were placed in a ground-necked tube equipped with a nitrogen inlet and outlet and magnetic-flea stirring. The mixture was stirred for 4 hours at 110° C. under a nitrogen flow rate of 500 mL/minute. The reaction medium was extracted three times with 10 mL of chloroform. After evaporating off the chloroform, 260 mg of a white solid were obtained. Mw=38200, ¹H NMR (DMSO-d₆, 300 MHz, ref. δ (DMSO)=2.50 ppm): δ=5.19 (1H, q); 1.46 ppm (3H, d).

### Example 5

### Preparation of a copolyester of 12-hydroxydodecanoic acid (12-HDA) and of glycolic acid (GA)

303 mg of 12-HDA (1.4 mmol-70%-mol), 46 mg of GA (0 6 mmol-30%-mol) and 719 mg (2 mmol) of BIm4S.HSO₄ were placed in a ground-necked tube equipped with a nitrogen inlet and outlet and magnetic-flea stirring. The mixture was stirred for 2 hours at 110° C. under a nitrogen flow rate of 500 mL/minute. 10 ml of 2-propanol were then added and the reaction medium was refluxed for 10 minutes. After cooling with stirring, the white precipitate obtained was filtered off and dried under vacuum. 240 mg of white solid were recovered. Mw=15500; ¹H NMR (CDCl₃, 300 MHz, ref. δ (CHCl₃)=726 ppm): δ=4.82 (2H, s) 4.72 (2H, s); 4.68 (2H, s); 4.59 (2H, s); 4.16 (2H, t); 4.05 (2H, t); 2.43 (2H, t); 2.30 (2H, t); 1.64 (4H, t); 1.37 ppm (14H, t).

### Example 6

### Preparation of a polyester of succinic acid and of 1,12-dodecanediol by post-polyesterification of an oligomer

311 mg of oligo(dodecamethylene succinate) (Mw=2000) and 622 mg of [BIm4S].HSO₄ were placed in a ground-necked tube equipped with a nitrogen inlet and outlet and a magnetic flea of two-sided crosshead type. The mixture was stirred for 2 hours at 110° C. under a nitrogen flow rate of 500 mL/minute. 10 ml of 2-propanol were then added and the reaction medium was heated at 85° C. for 5 minutes. After cooling with stirring, a white solid was obtained. After filtering off and drying under vacuum, 233 mg of white solid were recovered. Mw=25800; ¹H NMR (CDCl₃, 300 MHz, ref. δ (CHCl₃)=7.26 ppm): δ=4.07 (4H, t); 2.61 (4H, s); 1.61 (8H, m); 1.26 ppm (16H, m).

### Example 7

### Preparation of a polyester of dodecanedioic acid and of 1,12-dodecanediol by post-polyesterification of an oligomer

300 mg of oligo(dodecamethylene dodecanoate) (Mw=1800) and 600 mg of BIm4S.HSO₄ were placed in a ground-necked tube equipped with a nitrogen inlet and outlet and a magnetic flea of two-sided crosshead type. The mixture was stirred for 2 hours at 110° C. under a nitrogen flow rate of 500 mL/minute. 10 ml of 2-propanol were then added and the reaction medium was heated at 85° C. for 5 minutes. After cooling with stirring, a white solid, was obtained. After filtering off and drying under vacuum, 240 mg of white solid were recovered. Mw=21600; ¹H NMR (CDCl₃, 300 MHz, ref. δ (CHCl₃)=7.26 ppm): δ=4.04 (4H, t); 2.28 (4H, t); 1.60 (8H, m); 1.27 ppm (28H, m).

### Example 8

### Preparation of a polyester of bis(2-hydroxyethyl)terephthalate and of dodecanedioic acid

127 mg of bis(2-hydroxyethyl)terephthalate (0.5 mmol), 1.15 mg of dodecanedioic acid (0.5 mmol) and 358 mg of [BIm4S].HSO₄ (1 mmol) were placed in a ground-necked tube equipped with a nitrogen inlet and outlet and a magnetic flea of two-sided crosshead type. The mixture was stirred for 1 hour at 110° C. under a nitrogen flow rate of 500 mL/minute. 10 ml of 2-propanol were then added and the reaction medium was heated at 85° C. for 5 minutes. After cooling with stirring, a white solid was obtained. After filtering off and drying under vacuum, 204 mg of white solid were recovered. Mw=28300; ¹H NMR (CDCl₃, 300 MHz, ref. δ (CHCl₃)=7.26 ppm): δ=8.10 (4H), 4.70-4.26 (8H, m), 2.32 (4H, t); 1.60 (4H, m); 1.24 ppm (12H, m).

### Example 9

### Preparation of a polyester of bis(2-hydroxyethyl)terephthalate and of dodecanedioic acid by post-polyesterification of an oligomer

300 mg of an oligomer (Mw=680), obtained by reaction between bis(2-hydroxyethyl)terephthalate and dodecanedioic acid (1/1 mol/mol), and 600 mg of [BIm4S].HSO₄ were placed in a ground-necked tube equipped with a nitrogen inlet and outlet and a magnetic flea of two-sided crosshead type. The mixture was stirred for 1 hour at 110° C. under a nitrogen flow rate of 500 mL/minute. 10 ml of 2-propanol were added and the reaction medium was then heated at 85° C. for 5 minutes. After cooling with stirring, a white solid was obtained. After filtering off and drying under vacuum, 265 mg of a white solid were recovered. Mw=25200; ¹H NMR (CDCl₃, 300 MHz, ref. δ (CHCl₃)=7.26 ppm): δ=7.26 ppm): δ=8.10 (4H), 4.70-4.26 (8H, m), 2.32 (4H, t); 1.60 (4H, m); 1.24 ppm (12H, m).

1. A process for synthesizing polyesters or copolyesters with a mass-average molar mass M_{W} of greater than 10 000, said mass-average molar mass being measured by steric exclusion chromatography, said process comprising;
i) a polyesterification reaction between at least a first monomer or oligomer selected from the group consisting of compounds bearing at least two carboxylic acid functions, compounds bearing at least two carboxylic acid ester functions, compounds bearing at least one carboxylic acid function and at least one hydroxyl function, compounds bearing at least one carboxylic acid ester function and at least one hydroxyl function, and at least a second monomer or oligomer selected from the group consisting of compounds bearing at least two hydroxyl functions, or
ii) a polyesterification reaction of a single monomer or oligomer selected from the group consisting of compounds bearing at least one carboxylic acid function and at least one hydroxyl function and compounds bearing at least one carboxylic acid ester function and at least one hydroxyl function;
wherein said polyesterification reaction is performed at a temperature from 60 to 150° C., at atmospheric pressure or under vacuum, in a reaction medium free of metallic catalyst and comprising at least one acidic ionic liquid formed from an anion and the cation whose electrical charges are equilibrated and in which at least the cation is a strong acid in the Bronsted sense or comprises a group that is a strong acid in the Bronsted sense.

2. The process as claimed in claim 1, wherein the polyesterification reactions are condensation reactions (1) between groups of carboxylic acid type and groups of alcohol type, and/or (2) between groups of carboxylic acid ester type and groups of alcohol type and/or (3) between groups of carboxylic acid type and groups of carboxylic acid ester type, said reactions being respectively written:
R—COOH (group A)+HO—R′ (group B)→R—COO—R′+H₂O (1)
R—COOR¹ (group A)+HO—R′ (group B)→R—COO—R′+R¹OH (2)
R—COOH (group A)+R²COO—R′ (group B)→R—COO—R′+R²COOH (3)
in which:
R and R′, independently of each other, represent any type of monomer, oligomer or polymer molecule that can lead to a polymer molecule of high molar mass,
R¹ is an alkyl group, and
R² is an alkyl group.

3. The process as claimed in claim 2, wherein the compounds reacted together to perform the polyesterification reaction bear either one or more groups of type A and are selected from the group consisting of compounds of the type Aₓ corresponding to formula I below (A)ₓR³, or one or more groups of the type B and are selected from the group consisting of compounds of the type Bₓ corresponding to formula II below (B)_{y}R⁴, or one or more groups of the type A and one or more groups of the type B and are selected from the group consisting of compounds of the type AₓB_{y} corresponding to formula III below (A)ₓR⁵(B)_{y}, in which formulae I, II and III;
x and y are integers greater than or equal to 1, and
the groups R³, R⁴ and R⁵, independently of each other, are aliphatic, cycloaliphatic, aromatic or mixed groups, optionally containing heteroatoms or groups that are not reactive under the synthetic conditions used, for example ketone, sulfone, amide or nine groups.

4. The process as claimed in claim 1, wherein the compounds reacted together to perform the polyesterification reaction contain either two groups of the type A (compounds of type A₂), or two groups of the type B (compounds of type B₂), or a group of the type A and a group of the type B (compounds of type AB) and the polyester or copolyester obtained is of linear architecture.

5. The process as claimed in claim 1, wherein the esterification reaction is performed by reacting either one or more compounds containing only one group of type A and several groups of type B (compounds of the type ABₓ), or one or more compounds containing several groups of type A and only one group of type B (compounds of the type AₓB) and the polyester or copolyester obtained is of highly branched architecture.

6. The process as claimed in claim 1, wherein one or more of the compounds reacted are oligomers bearing reactive groups of the type A and/or B and in that the polyesters obtained contain polymer blocks of different types.

7. The process as claimed in claim 1, wherein the ionic liquids are selected from the group consisting of ionic, liquids of formula qXⁿ⁺nY^{q-} in which Xⁿ⁺ denotes an acidic cation bearing a positive charge (n=1) or several positive charges (n>1) and Y^{q-} denotes an anion bearing a negative charge (q=1) or several negative charges (q>1), and in which the cations Xⁿ⁺ are selected from the group consisting of ammoniums, imidazoliums, pyridiniums, pyrrolidiniums, piperidiniums, triazothans, morpholiniums and phosphoniums of general formulae X1 to X8 below: 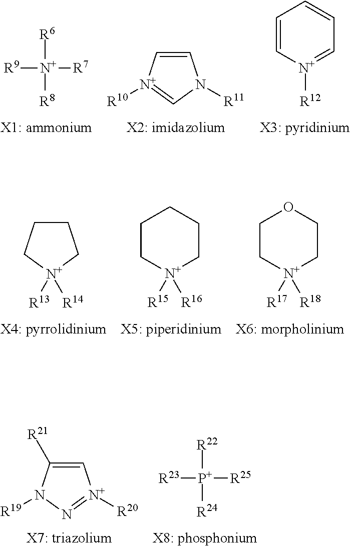
in which:
the radicals R⁶ to R¹¹ and R¹³ to R²⁵, independently of each other, represent a hydrogen atom, an alkylsulfonic acid group of formula —(CH₂)ₘ—SO₃H, in which m is an integer ranging from 1 to 6, an aliphatic group, a cycloaliphatic group, an aromatic group or a mixed group, said groups optionally containing one or more heteroatoms; it being understood that in each of the cations of formulae X1 to X8 above, at least one of the radicals Rⁿ represents a hydrogen atom or an alkylsulfonic acid group of formula —(CH₂)ₘ—SO₃H,
R¹² represents a hydrogen atom or an alkylsulfonic acid group of formula —(CH₂)ₚ—SO₃H, in which p is an integer ranging from 1 to 6.

8. The process as claimed in claim 7, wherein the anion Y^{q-} is selected from the group consisting of halides; tetrafluoroborate, hexafluorophosphate, sulfate, hydrogen sulfate, dihydrogen phosphate, hydrogen phosphate and phosphate anions; carboxylate anions; acetate anions; trifluoroacetate anions; propanoate anions; bis((trifluoromethyl)sulfonyl)imidate anions; bis(methylsulfonyl)imidate anions; dicyanamidate anions and sulfonate anions.

9. The process as claimed in claim 7, wherein the anion Y^{q-} comprises at least one Bronsted acid group selected from the group consisting of the acidic anions of protic polyacids.

10. The process as claimed in claim 1, wherein the ionic liquid is chosen from 3-(3-alkyl-1-imidazolio)-1-propanesulfonic acids and 4-(3-alkyl-1-imidazolio)-1-butanesulfonic acids of formula (IV) below: 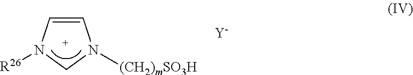
in which m=3 or 4, Y is chosen from the anions Y^{q-} as defined in claim 8 or 9 and R²⁶ is an aliphatic group, a cycloaliphatic group, an aromatic group or a mixed group, said groups optionally containing one or more heteroatoms.

11. The process as claimed in claim 10, wherein the ionic liquids of formula (IV) are selected from the group consisting of the hydrogen sulfates, trifluoromethanesulfonates, tosylates, dihydrogen phosphates and bis(trifluoromethylsulfonyl)imidates of the acids:
4-(3-methyl-1-imidazolio)-1-butanesulfonic, 3(3-methyl-1-imidazolio)-1-propanesulfonic, 4-(3-ethyl-1-imidazolio)-1-butanesulfonic, 3-(3-ethyl-1-imidazolio)-1-propanesulfonic, 4-(3-propyl-1-imidazolio)-1-butanesulfonic, 3-(3-propyl-1-imidazolio)-1-propanesulfonic, 4-(3-butyl-1-imidazolio)-1-butanesulfonic, 3-(3-butyl-1-imidazolio)-1-propanesulfonic, 4-(3-isobutyl-1-imidazolio)-1-butanesulfonic, 3-(3-isobutyl-1-imidazolio)-propanesulfonic, 4-(3-pentyl-1-imidazolio)-1-butanesulfonic, 3 -(3-pentyl-1-imidazolio)- 1-propanesulfonic, 4-(3-hexyl-1-imidazolio)-1-butanesulfonic, 3-(3-hexyl-1-imidazolio)-1-propanesulfonic, 4-(3-octyl-1-imidazolio)-1-butanesulfonic, 3-(3-octyl-1-imidazolio)-1-propanesulfonic, 4-(3-dodecyl-1-imidazolio)-1-butanesulfonic, 3-(3-dodecyl-1-imidazolio)-1-propanesulfonic, 4-(3-octadecyl-1-imidazolio)-1-butanesulfonic, 3-(3-octadecyl-1-imidazolio)-1-propanesulfonic, 4-(3-(2-methoxyethyl)-1-imidazolio)-1-butanesulfonic, 3-(3-(2-ethoxyethyl)-1-imidazolio)-1-propanesulfonic, 4-(3-(2-methoxyethyl)-1-imidazolio)-1-butanesulfonic, 3-(3-(2-methoxyethyl)-1-imidazolio)-1-propanesulfonic, 4-(3-(2(2-methoxyethoxy)ethyl)-1-imidazolio)-1-butanesulfonic and 3-(3-(2(2-methoxyethoxy)ethyl)-1-imidazolio)-1-propanesulfonic.

12. The process as claimed in claim 1, wherein the reaction medium also comprises at least one nonacidic ionic liquid selected from the group consisting of 1-butyl-3-methylimidazolium chloride, 1-butyl-3-methylimidazolium tetrafluoroborate and butyl-3-methytimidazolium bis(trifluoromethylsulfonyl)imide.

13. The process as claimed in claim 1, wherein the temperature of the reaction medium is from 80 to 120° C. at atmospheric pressure.

14. The process as claimed in claim 1, wherein the polyesterification reaction is performed for 30 minutes at 110° C.

15. The process as claimed in claim 1, wherein a stream of inert gas is introduced over or into the reaction medium during the polyesterification reaction.

16. The process as claimed in claim 1, wherein a vacuum of 0.1 to 100 mbar is applied over the reaction medium during the polyesterification reaction.

17. The process as claimed in claim 2, wherein R¹ is selected from the group consisting of a methyl, ethyl, propyl, isopropyl, butyl or isobutyl group.

18. The process as claimed in claim 2, wherein R² is selected from the group consisting of a methyl or ethyl group.

19. The process as claimed in claim 3, wherein the groups R³, R⁴ and R⁵ independently of each other, contain heteroatoms or groups that are not reactive under the synthetic conditions used.

20. The process as claimed in claim 19, wherein the heteroatoms or groups that are not reactive under the synthetic conditions used are selected from the group consisting of ketone, sulfone, amide or imine groups.
